(19) United States
(12) Patent Application Publication
(10) Pub. No.: US 2017/0086166 A1
(43) Pub. Date: Mar. 23, 2017

(54) PAGING MESSAGE MONITORING IN ELECTRONIC DEVICES

(71) Applicant: QUALCOMM Incorporated, San Diego, CA (US)

(72) Inventors: Vishnu Vardhan Kasilya Sudarsan, Hyderabad (IN); Tushar Gupta, Hyderabad (IN); Sagar, Hyderabad (IN); Debesh Kumar Sahu, Hyderabad (IN); Venkata Siva Prasad Rao Gude, San Diego, CA (US)

(21) Appl. No.: 14/861,874

(22) Filed: Sep. 22, 2015

(51) Int. Cl. H04W 68/02; H04W 52/02

(52) U.S. Cl. CPC H04W 68/02; H04W 52/0209; H04W 84/042

(57) ABSTRACT

Some embodiments include a method for processing wireless wide area network paging messages. The method may include receiving, in a fixed device over a wireless local area network (WLAN) interface, a request to monitor wireless wide area network (WWAN) paging messages for a mobile device. The method may include receiving, by the fixed device via a WWAN interface, a WWAN paging message of the WWAN paging messages. The method may also include forwarding, by the fixed device via the WLAN interface, the paging message to the mobile device.

### BACKGROUND

Embodiments of the disclosure generally relate to the field of computer network communications, and more particularly to monitoring for paging message of various devices.

Mobile devices (e.g., smart phones) offer broad utility including application programs, voice services, data services, and more. Given such broad utility, there is a need for longer mobile device battery life. Under certain circumstances, mobile devices may conserve power by entering low-power states. For example, when a mobile device has no scheduled communications and computations, the mobile device may turn-off power to communication interfaces, processing elements, and other components. Additionally, in some environments, mobile devices may conserve power by utilizing access points for relatively low-power data communications. Using a wireless local area network (WLAN) may prolong battery life because WLAN communications may require less power than communications over a wireless wide area network (WWAN). Despite these techniques for improving mobile device battery life, there is growing demand for longer mobile device battery life.

### SUMMARY

Some embodiments include a method for processing wireless wide area network paging messages. The method may include receiving, in a fixed device over a wireless local area network (WLAN) interface, a request to monitor wireless wide area network (WWAN) paging messages for a mobile device. The method may include receiving, by the fixed device via a WWAN interface, a WWAN paging message of the registered WWAN devices. The method may also include forwarding, by the fixed device via the WLAN interface, the paging message to the mobile device.

### BRIEF DESCRIPTION OF THE DRAWINGS

The present embodiments may be better understood by referencing the accompanying drawings.

FIG. 1 is a block diagram illustrating a system in which a fixed device processes paging messages on behalf of mobile devices.

FIG. 2 is a diagram showing components and operations for delegating page monitoring to a fixed device, according to some embodiments.

FIG. 3 is a diagram showing components and operations for delegating page monitoring to a fixed device, according to some embodiments.

FIG. 4 depicts a mobile device, according to some embodiments.

FIG. 5 depicts a fixed device, according to some embodiments.

### DESCRIPTION OF EMBODIMENT(S)

### Introduction to Some Embodiments

Mobile devices (e.g., smart phones) may receive voice calls and data over WWANs (e.g., Long-term Evolution “LTE” networks). To be accessible for the voice calls, a mobile device may monitor a WWAN for WWAN paging messages (hereinafter “paging messages”). Paging messages notify the mobile device about incoming WWAN voice calls, available WWAN data, emergency messages, and other WWAN events. To monitor for paging messages, the mobile device's WWAN interface must periodically wakeup and process data from the WWAN. Some mobile devices monitor for paging messages according to a particular paging cycle (e.g., every 1.28 seconds for some LTE networks). Even though paging message monitoring may not be continuous, periodic operation of the WWAN interface may deplete the mobile device's battery.

Some embodiments enable mobile devices to avoid periodic paging message monitoring. That is, some embodiments enable a mobile device to offload paging message monitoring to a fixed device. The fixed device (instead of the mobile device) periodically monitors the WWAN for paging messages. If the fixed device detects a paging message associated with the mobile device, the fixed device forwards the paging message to the mobile device. The fixed device may notify the mobile device over a WLAN connection. The mobile device may save power by offloading paging message monitoring to the fixed device. The mobile device may further save power by receiving paging messages from the fixed device over a relatively lower power WLAN interface (instead of a WWAN interface).

### Description of Some Embodiments

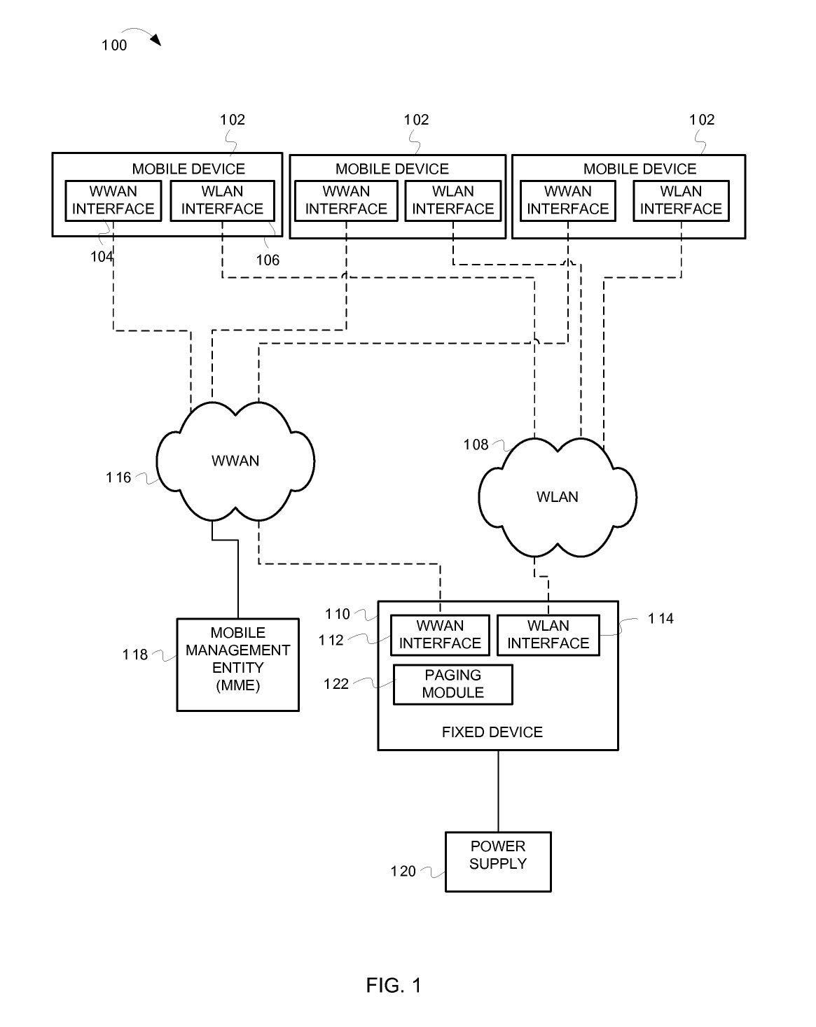

FIG. 1 is a block diagram illustrating a system in which a fixed device processes paging messages on behalf of mobile devices. In FIG. 1, mobile devices 102 and a fixed device 110 may communicate over a WLAN 108 and a WWAN 116. The mobile devices 102 may be any suitable devices, including mobile phones, smartphones, tablet computers, laptop computers, etc. As described below, the mobile devices 102 may communicate over WWANs (e.g., mobile telephone networks), local area networks, and any other suitable communication networks. Each mobile device 102 is powered by a rechargeable battery (not shown) that discharges through operations of the mobile device 102. Each mobile device 102 includes a WWAN interface 104 and WLAN interface 106. The WWAN interface 104 may include a modem capable of communicating over the WWAN 116, where the WWAN 116 includes a mobile telephone network. Each mobile device may use its WLAN interface 106 to communicate over the WLAN 108. The WLAN 108 and WLAN interface 106 may communicate using Institute of Electrical and Electronics Engineers (IEEE) 802.11 protocols (a.k.a. Wireless Fidelity “Wi-Fi” protocols), or any other suitable local area network technologies.

The fixed device 110 includes a WWAN interface 112 and WLAN interface 114. The fixed device 110 may use the WWAN interface 112 to communicate over the WWAN 116, and the WLAN interface 114 to communicate over the WLAN 108. Furthermore, the fixed device 110 may be connected to a relatively constant power supply 120 (e.g., a public power utility). Although not shown, the fixed device 110 may be communicatively connected to other networks (e.g., data networks for processing Internet and other data traffic). For example, the fixed device may include a wireline connection to a public switched telephone network, connections to WWANs for providing data backhaul to other devices (e.g., mobile devices 102), and/or other suitable voice/data networks (not shown). In some embodiments, the fixed device 110 may act as a wireless access point for the mobile devices 102. That is, the fixed device 110 may provide wireless access to wired and/or wireless data networks (not shown). In some embodiments, the fixed device 110 is a WWAN-based device, and does not include a wired network connection. In some embodiments, the fixed device 110 includes an external antennae that improves its own WWAN coverage, and thereby improving WWAN coverage for the mobile device 102.

In FIG. 1, a mobility management entity (MME) 118 is communicatively connected to the WWAN 116. Although not shown, the WWAN 116 may include devices that facilitate wireless voice and/or data exchange between the mobile devices 102 and/or other electronic devices (land-based telephones, computers, etc.). For example, the WWAN 116 may include base stations, base station controllers, other MMEs, etc.

In wireless networks, mobile devices (e.g., mobile smartphones) move around, registering with different wireless network components in different geographic locations. MMEs perform a paging function to locate mobile devices when there are incoming voice calls or data traffic. For example, an MME 118 may attempt to locate a particular mobile device by sending a paging message to all the base stations (not shown) in a smaller geographical area, normally referred to as location area in which the mobile device was registered. If the mobile device 102 is present in any of the base stations, the mobile device 102 will receive the paging message. After locating the mobile device, the MME 118 may facilitate the voice call, deliver data traffic to the mobile device, etc.

As described above, the fixed device 110 may assume responsibility for paging message monitoring for the mobile devices 102. The fixed device 110 includes a paging module 122, which handles the registration of mobile devices 102, and monitors for their paging messages. If the paging module 122 detects (via WWAN interface 112) paging messages for registered mobile devices, the paging module 122 forwards the paging messages to the mobile devices 102 (via WLAN interface 114). This process enables the mobile devices 102 to conserve power, thereby extending operation time between battery charges. The fixed device 110 is connected to a relatively constant power source, so monitoring for paging messages will not necessitate battery recharging.

In some embodiments, the mobile devices 102 registers with only certain fixed devices that are known to be reliable, and that are in relatively close WLAN proximity. In some embodiments, the mobile device 102 determines that a fixed device is within a specified proximity. Additionally, the mobile devices 102 registers with only fixed devices utilizing the same network provider, on the same remote access technology (RAT), and in the same paging area.

The description will continue with operations by which fixed devices monitor for paging messages on behalf of mobile devices.

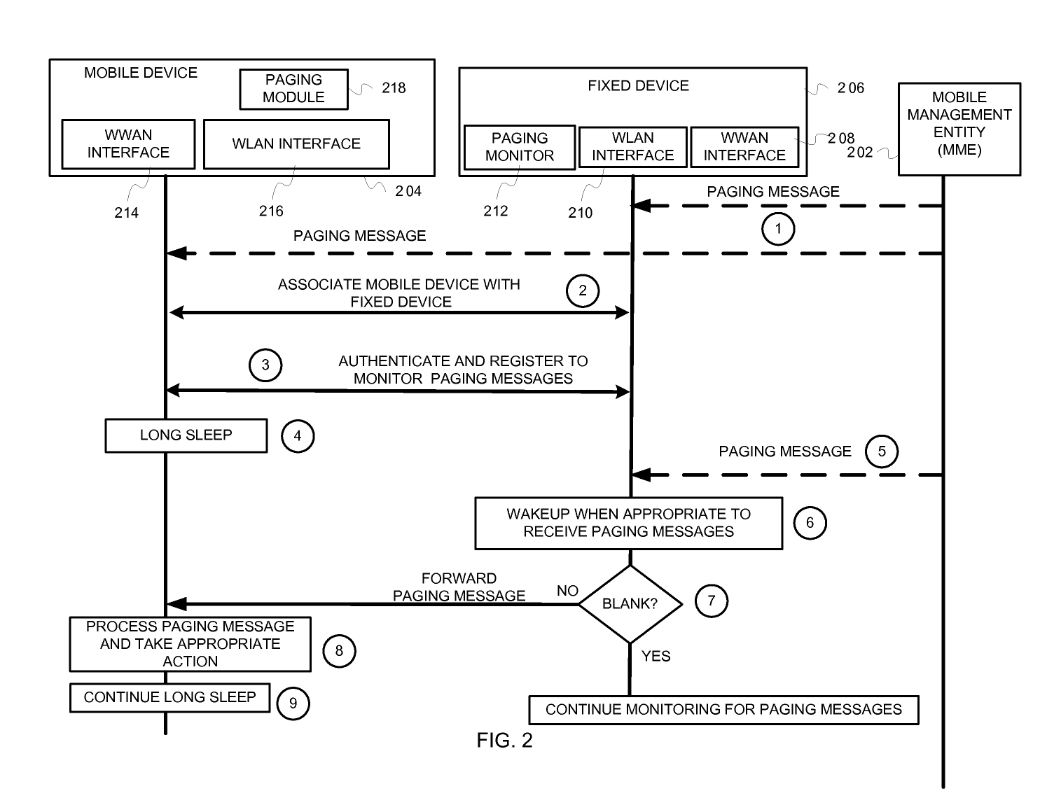

FIG. 2 is a diagram showing components and operations for delegating page monitoring to a fixed device, according to some embodiments. In FIG. 2, the operations are performed by an MME 202, a fixed device 206, and a mobile device 204. The fixed device 206 includes a WWAN interface 208, WLAN interface 210, and paging monitor 212. The mobile device 204 includes a WWAN interface 214, WLAN interface 216, and paging module 218. FIG. 2 shows operations occurring in ten stages.

During stage one, the MME 202 transmits paging messages over a WWAN. In some implementations, the WWAN is an LTE network. In an LTE network, the devices may inter alia monitor a physical downlink shared channel (PDSCH) and physical downlink control channel (PDCCH) to receive paging messages. At this point in time, the mobile device 204 has not yet registered with the fixed device 206 to monitor for paging messages. However, the fixed device 206 may be monitoring for other mobile devices (not shown) that have already registered. The fixed device 206 and mobile device 204 receive the MME's paging message via their WWAN interfaces (208 and 214). The paging messages may indicate that one or more of the devices has an incoming voice call, incoming data, an emergency message, etc. The mobile device 204 responds to the paging message by taking measures according to LTE protocols (e.g., measures to initiate a voice call, receive data, etc.). Likewise, the fixed device 206 initiates operations for receiving a voice call, data, etc. The fixed device 206 may also forward the paging message to other registered devices (not shown).

During stage two, the mobile device 204 associates with the fixed device 206. The mobile device 204 may associate with the fixed device 206 according to Wi-Fi protocols. For example, the mobile device 204 may send (via WLAN interface 216) the fixed device 206 a Wi-Fi association request and other information. The fixed device 206 may grant the association request, and establish a wireless connection via its WLAN interface 210. After the mobile device 204 associates with the fixed device 206, the devices are configured to communicate with each other via a WLAN.

During stage three, after the mobile device 204 associates with the fixed device 206, the fixed device 206 authenticates the mobile device 204. The mobile device 204 may provide authentication credentials to the fixed device 206, over the WLAN interface 216. The authentication credentials may include a user identifier and password. In turn, fixed device 206 compares the provided password with a stored password associated with the user identifier. If the passwords (or other authentication credentials) match, the mobile device 204 is authenticated. If the passwords do not match, the fixed device 206 terminates the association with the mobile device 204.

Also during stage three, the mobile device 204 registers with the fixed device 206. Registration enlists the fixed device 206 to monitor for the mobile device's paging messages. To register, the mobile device 204 provides one or more parameters that enable the fixed device 206 to identify paging messages that may be intended for the mobile device 204. In some embodiments, the mobile device's paging module 218 transmits the parameters via the WLAN interface 216. In an LTE wireless network, the fixed device 206 needs the mobile device's paging frame number and paging occasion to procure the mobile device's paging messages. Hence, in some embodiments, the parameters explicitly include the paging frame number and paging occasion. Alternatively, the parameters may include values for determining the mobile device's paging frame number and paging occasion. Values for deriving the mobile device's paging frame number may include one or more of: the mobile device's LTE network user equipment identifier (i.e., the mobile device's EU_ID), T=the mobile device's discontinuous reception (DRX) cycle, and N=the number of radio frames in the mobile device's DRX cycle. Values for deriving the mobile device's paging occasion may include: Iₛ=Floor ((mobile device's EU_ID/Ns) mod Ns), where Iₛ an index into a table of values indicting a corresponding paging occasion value. In some embodiments, the fixed device 206 has the table or has access to the table. Some implementations configure the table as defined in The 3rd Generation Partnership Project (3GPP) technical specification 36.304. Also from the above-noted equation, Nₛ=Max(1,nB/T), where nB indicates the number of sub-frames in each radio frame, and is available in system information blocks provided by the LTE network.

After determining the mobile device's paging frame number and paging occasion, the fixed device 206 begins monitoring for paging messages of registered mobile devices. Although FIG. 2 shows only one mobile device, the fixed device 206 may monitor for paging messages for a plurality of mobile device. The operations continue at stage four.

During stage four, the mobile device 204 puts the WWAN interface 214 into a long sleep mode, during which it does not expend battery power monitoring for paging messages on the WWAN.

During stage five, the MME 202 transmits a paging message intended for the mobile device 204. In an LTE network, the MME 202 periodically transmits radio frames over the PDSCH. The radio frames may include an identifier indicating that paging messages are available on the PDCCH, or the radio frames may be blank.

Although connected to a relatively constant power source, the fixed device 206 may keep the WWAN interface 208 in a sleep state to conserve power. The fixed device 206 may use paging frame numbers and paging occasions to determine when to wake up the WWAN interface 208 to monitor for paging messages. The fixed device 206 wakes up the WWAN interface 208 to check for paging messages intended for itself and registered devices.

During stage six, the fixed device 206 wakes up its WWAN interface 208 and monitors for the paging message. In an LTE network, the fixed device 206 detects the paging message by monitoring (via WWAN interface 208) the LTE network's PDSCH for a radio frame. If the radio frame does not include a certain identifier (e.g., a Paging Radio Network Temporary Identifier “P-RNTI”), the paging message is “blank”. However, if the radio frame includes the identifier, a paging message is available on the PDCCH.

During stage seven, the fixed device 206 determines whether the paging message is blank. As noted above, the fixed device 206 may monitor the LTE network's PDSCH for radio frames. If a radio frame includes a P-RNTI, there is a paging message on the LTE network's PDCCH. In turn, the fixed device's WWAN interface 208 decodes and modulates the PDCCH to procure the paging message. The paging message could be intended for any device registered with the fixed device 206.

If the paging message is blank, the fixed device 206 may put the WWAN interface 208 into a low-power state and continues to monitor for paging messages. If the paging message is not blank, the fixed device 206 forwards the paging message to the mobile device 204, and all other registered mobile devices. The fixed devices forwards the paging message via its WLAN interface 210. The mobile device 204 receives the paging message via its WLAN interface 216. As noted above, the mobile device's WLAN interface 216 may support Wi-Fi communications. Therefore, the mobile device 204 may receive the paging message as part of Wi-Fi communications from the fixed device 206.

During stage eight, the mobile device 204 processes the paging message, and takes appropriate action. As noted above, the paging message may not be intended for the mobile device 204. That is, the paging message may be intended for other registered devices. In processing the paging message, the mobile device 204 determines whether the paging message is intended for the mobile device 204. In some embodiments, paging messages intended for the mobile device 204 will include an identifier associated with the mobile device 204. In an LTE network, the identifier may be a System Architecture Evolution Temporary Mobile Subscriber Identity (S-TMSI) associated with the mobile device 204. Alternatively, the identifier may be an International Mobile Subscriber Identity (IMSI). In yet other embodiments, the identifier may be any suitable identifier that uniquely identifies the mobile device 204. If the paging message includes the mobile device's S-TMSI or IMSI, the paging message is intended for the mobile device 204. If the paging message is intended for the mobile device 204, the mobile device 204 takes appropriate action. For example, the mobile device may utilize LTE protocols to initiate a voice call, initiate data operations, etc.

During stage nine, the mobile device 204 puts the WWAN interface 214 in a long sleep state to conserve battery power.

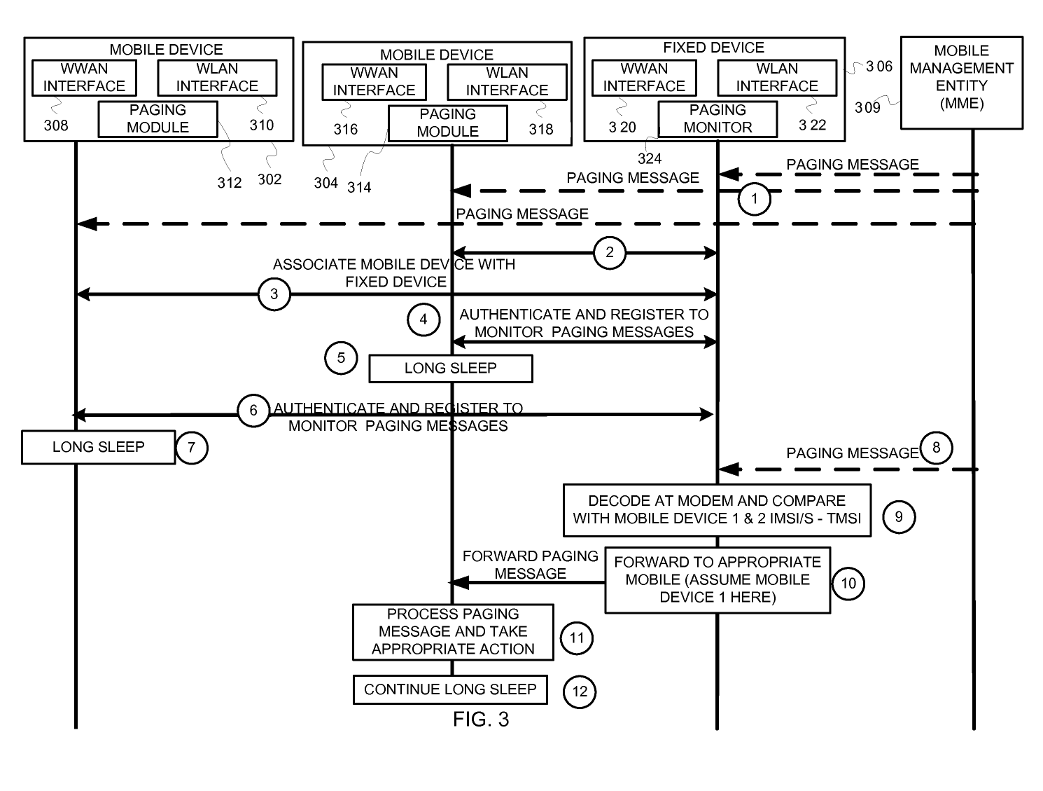

In FIG. 2, the fixed device 206 forwards all paging messages to all registered mobile devices. Therefore, a mobile devices may receive paging messages intended for different mobile devices. However, some embodiments of the fixed device forwards paging messages to only those mobile devices for which the paging messages are intended. That is, the fixed device does not forward a paging message to a particular mobile device, unless the paging message includes information indicating the paging message is intended for that particular mobile device. FIG. 3 shows operations for such an embodiment.

FIG. 3 is a diagram showing components and operations for delegating page monitoring to a fixed device, according to some embodiments. In FIG. 3, the components include a MME 309, fixed device 306, mobile device 304, and mobile device 302. The mobile device 302 includes a WLAN interface 310, WWAN interface 308, and paging module 312. The mobile device 304 includes a WLAN interface 318, WWAN interface 316, and paging module 314. The fixed device 306 includes a WLAN interface 322, WWAN interface 320, and paging monitor 324.

The operations shown in FIG. 3 occur in twelve stages. During stage one, the MME 309 transmits paging messages over a WWAN. At this point, the mobile devices 302 and 304 have not registered with the fixed device 306, so each device independently monitoring the WWAN for their own paging messages. The fixed device 306 and mobile devices 302 and 304 receive the paging messages via WWAN interfaces (see 320, 308, 316). In some implementations, the WWAN is an LTE network. In an LTE network, the devices may monitor a PDSCH and PDCCH to receive paging messages. FIG. 3 shows the mobile devices 302 and 304 and the fixed device 306 receiving the paging messages. After each device receives their paging message, each device independently processes the paging message, and takes appropriate action. For example, if one of the devices has an incoming voice call, the device takes actions for establishing the voice call.

The fixed device's WLAN interface 322 enables the fixed device 306 to operate as a Wi-Fi access point. During stages two and three, the mobile devices 302 and 304 each associate with the fixed device 306 via their WLAN interfaces 310 and 318.

During stage four, the mobile device 304 authenticates with the fixed device 306. The mobile device 304 may provide authentication credentials to the fixed device 306, over the WLAN interface 318. For example, the authentication credentials may include a user identifier and password. In turn, fixed device 306 compares the provided password with a stored password associated with the user identifier. If the passwords (or other authentication credentials) match, the mobile device 304 is authenticated. If the passwords do not match, the fixed device 306 terminates the association with the mobile device 304.

Also during stage four, the mobile device 304 registers with the fixed device 306 to monitor paging messages intended for the mobile device 304. The mobile device 304 and the fixed device 306 perform the registration process via their WLAN interfaces (318 and 322). In some embodiments, during the registration, the devices use their WLAN interfaces 318 and 322 to communicate using Wi-Fi protocols. As noted above, the fixed device 306 may deliver paging messages to only the intended recipients. Paging messages may include an identifier indicating the intended recipient. In LTE networks, the identifier is an IMSI or an S-TMSI. Therefore, as part of registration, the mobile device 304 provides its IMSI and/or S-TMSI to the fixed device 306.

During stage five, the mobile device 304 puts its WWAN interface 316 into a long sleep. Because the mobile device 304 has registered with the fixed device 306, the mobile device need not monitor the WWAN for its own paging messages. Therefore, mobile device 304 puts the WWAN interface 316 into a long sleep. The long sleep enables the mobile device 304 to conserve battery life by avoiding use of the WWAN interface 316 to monitor for paging messages.

During stage six, the mobile device 302 authenticates and registers with the fixed device 306 to monitor paging messages. As described above, the mobile device 302 provides its IMSI, S-TMSI, and/or other relevant identification information (see above discussion of stage four).

During stage seven, the mobile device 302 puts its WWAN interface 308 into a long sleep.

During stage eight, the MME 309 transmits a paging message over the WWAN. In some embodiment the WWAN is an LTE network. The fixed device 306 receives the paging message over its WWAN interface 320. As similarly discussed vis-à-vis FIG. 2, the fixed device 306 may use paging frame numbers, and paging occasions to determine when to monitor an LTE network's paging channels (e.g., PDSCH, PDCCH, etc.).

During stage nine, the fixed device 306 processes the paging message to determine the intended recipient. In some embodiments, the fixed device's paging monitor 324 determines whether the paging message includes an S-TMSI, IMSI, or other suitable identifier associated with any of the registered devices (i.e., mobile devices 302 and 304). For example, the paging monitor 324 may determine that the paging message includes an S-TMSI associated with the mobile device 304.

During stage ten, the fixed device's paging monitor 324 forwards a paging message to the appropriate registered mobile device. As noted above, the paging monitor 324 determined that the paging message included information intended for the mobile device 304. In response, the paging monitor 324 forwards a paging message (via the WLAN interface 322) to the mobile device 304. However, the paging monitor 324 does not forward the page to other registered devices, which are not intended recipients of the paging message.

During stage eleven, the mobile device 304 processes the paging message, and takes appropriate action. For example, the mobile device's paging module 314 inspects the paging message and initiates a response. In one embodiment, mobile device 304 performs operations for establishing a voice call. Hence, after receiving the paging message via the WLAN interface 318, the mobile device 304 wakes up its WWAN interface 316, and responds to the paging message via the WWAN.

During stage twelve, the mobile device 304 puts its WWAN interface 316 back into a long sleep to conserve battery life.

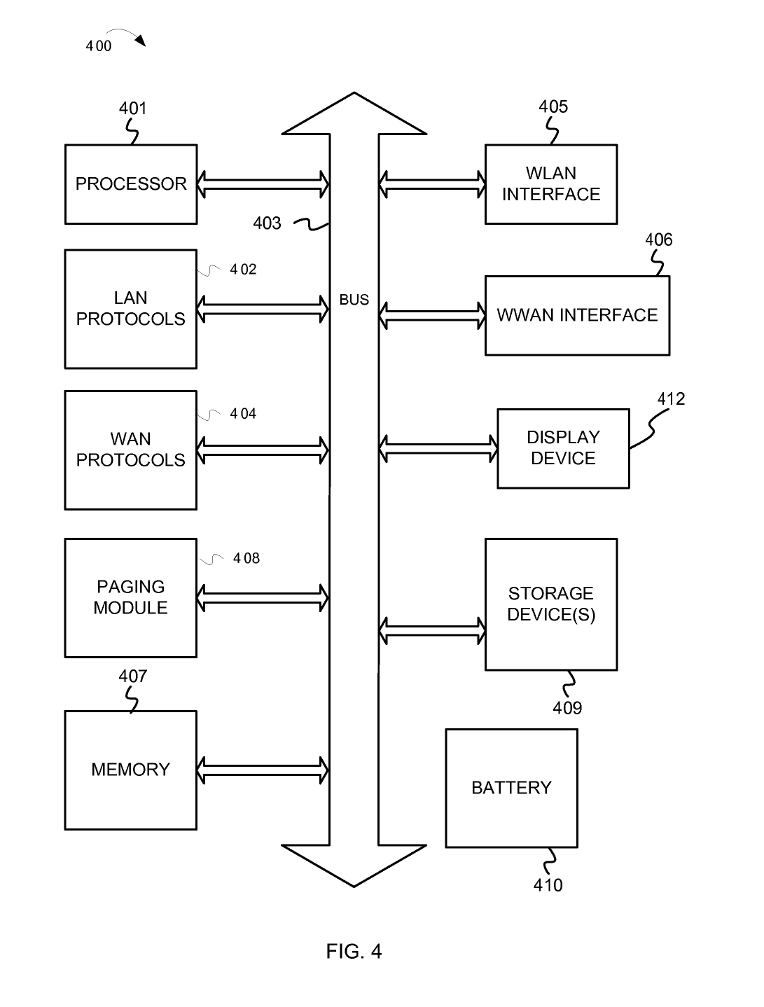

FIG. 4 depicts a mobile device, according to some embodiments. The mobile device 400 includes a processor 401, and may include multiple processors, multiple cores, multiple nodes, and/or implementing multi-threading, etc. The mobile device 400 also includes a memory 407. The memory 407 may be system memory, including Static Random Access Memory (RAM), Dynamic RAM, zero capacitor RAM, Twin Transistor RAM, Electrically Erasable Programmable Read Only Memory, etc.). The memory may include computer readable storage media, as described in more detail below. The mobile device 400 also includes a bus 403, a WLAN interface 405 (e.g., a Wi-Fi interface), WWAN interface 406, and a storage device(s) 409 (e.g., optical storage, magnetic storage, etc.). The mobile device also includes a display device 412.

The mobile device 400 also includes WAN protocols 404 and LAN protocols 402. In some embodiment (not shown), a portion of the WAN protocols 404 and LAN protocols 402 include program code executable on the processor 401, and residing in the memory 407. Furthermore, a portion of the WAN protocols 404 and LAN protocols 402 may include application specific integrated circuits and other components (not shown). The WAN protocols 404 utilize the WWAN interface 406 to conduct communications over a WWAN (e.g., an LTE wireless telephone network). The LAN protocols 402 utilize the WLAN interface 405 to conduct communications over a WLAN (e.g., Wi-Fi network). Therefore, embodiments of the mobile device 400 may communicate over wireless telephone networks, and over wireless local area networks.

The mobile device 400 also includes a paging module 408 capable of registering with fixed devices configured to monitor for paging messages. As described above, the paging module 408 may utilize a WLAN to register with a fixed device, and receive paging messages from the fixed device. In responding to paging messages, the mobile device 400 may connect to a WLAN and take various actions. Some or all of the operations of the paging module 408 may be implemented with code embodied in the memory and/or processor, co-processors, other cards, etc. Any one of these operations may be partially (or entirely) implemented in hardware and/or on the processor 401. For example, the operations may be implemented with an application specific integrated circuit, in logic implemented in the processor 401, in a co-processor on a peripheral device or card, etc. Furthermore, the paging module 408 may be integrated with the LAN protocols 402 or WAN protocols 404.

The mobile device 400 also includes a battery 410 that powers all components and operations. The battery 410 may include any suitable battery, including a nickel-cadmium battery, Lithium Ion battery, etc. When the mobile device 400 puts the WWAN interface 406 in a long sleep mode, the battery 410 provides relatively far less power to it than when the WWAN interface 406 is fully operational.

In FIG. 4, the processor 401, the storage device(s) 409, the memory 407, WLAN interface 405, LAN protocols 402, WWAN interface 406, WAN protocols 404, paging module 408, and display device 412 are coupled to the bus 403. Although illustrated as being coupled to the bus 403, the memory 407 may be coupled to the processor 401.

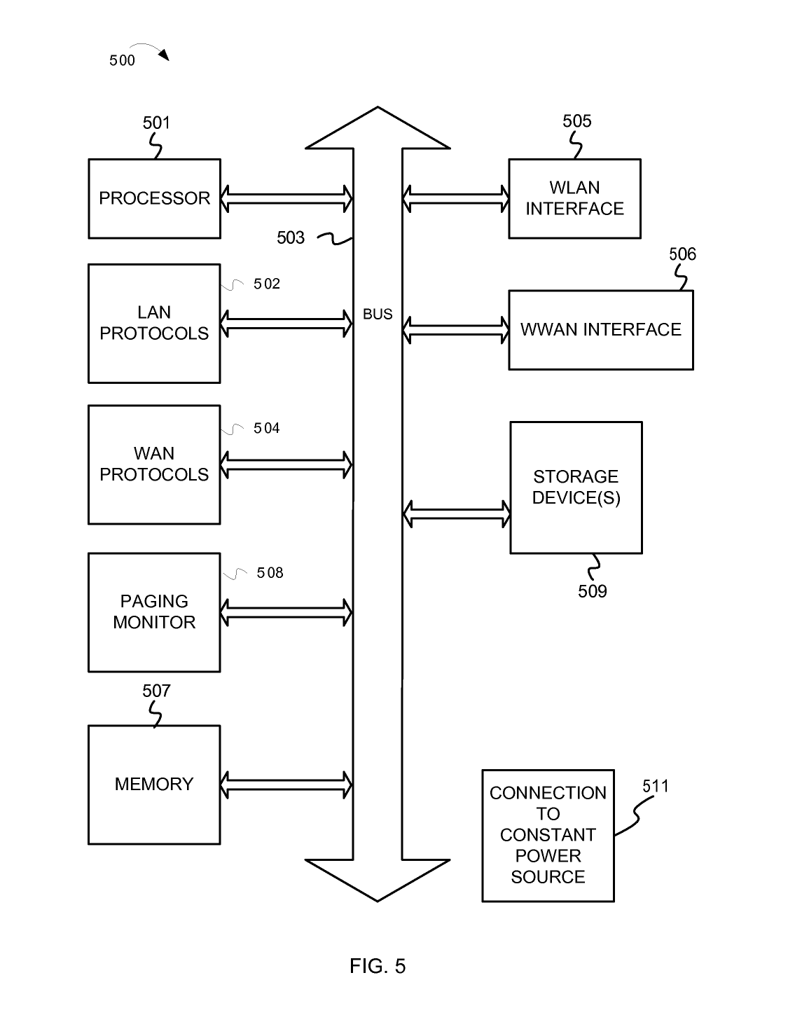

FIG. 5 depicts a fixed device, according to some embodiments. The fixed device 500 includes a processor 501, and may include multiple processors, multiple cores, multiple nodes, and/or implementing multi-threading, etc. The fixed device 500 also includes a memory 507. The memory 507 may be system memory, including Static Random Access Memory (RAM), Dynamic RAM, zero capacitor RAM, Twin Transistor RAM, Electrically Erasable Programmable Read Only Memory, etc.). The memory may include one or more computer readable storage mediums, as described in more detail below. The fixed device 500 also includes a bus 503, a WLAN interface 505 (e.g., a Wi-Fi interface), WWAN interface 506, and a storage device(s) 509 (e.g., optical storage, magnetic storage, etc.). The fixed device 500 also includes a display device 512.

The fixed device 500 also includes WAN protocols 504 and LAN protocols 502. In some embodiment (not shown), a portion of the WAN protocols 504 and LAN protocols 502 include program code residing in the memory 507. Furthermore, a portion of the WAN protocols 404 and LAN protocols 502 may include application specific integrated circuits and other components (not shown). The WAN protocols 504 utilize the WWAN interface 506 to conduct communications over a WWAN (e.g., an LTE wireless telephone network). The LAN protocols 502 utilize the WLAN interface 505 to conduct communications over a WLAN (e.g., a Wi-Fi network, Ethernet network, etc.). In some embodiments, the fixed device 500 is connected to a wired network, and may act as an access point enabling mobile devices to access the wired network via Wi-Fi. In other embodiments, the fixed device 500 establishes a WLAN including registered mobile devices, but does not provide access to any other network. Therefore, embodiments of the fixed device 500 communicate over wireless telephone networks (e.g., LTE networks), and over wireless local area networks (e.g., Wi-Fi networks).

The fixed device 500 also includes a paging monitor 508 capable of registering with mobile devices to monitor for their paging messages. As described above, the paging monitor 508 may utilize a WLAN to register with mobile devices, and forward paging messages to the mobile devices. Some or all of the operations of the paging monitor 508 may be implemented with code embodied in the memory and/or processor, co-processors, other cards, etc. Any one of these operations may be partially (or entirely) implemented in hardware and/or on the processor 501. For example, the operations may be implemented with an application specific integrated circuit, in logic implemented in the processor 501, in a co-processor on a peripheral device or card, etc.

The fixed device 500 also includes a connection 511 to a relatively constant power source (e.g., a public utility). The connection 511 provides power to all components and operations of the fixed device 500.

In FIG. 5, the processor 501, the storage device(s) 509, the memory 507, WLAN interface 505, LAN protocols 502, WWAN interface 506, WAN protocols, and paging monitor 508 are coupled to the bus 503. Although illustrated as being coupled to the bus 503, the memory 507 may be coupled to the processor 501.

As will be appreciated by one skilled in the art, embodiments may be implemented as a system, method, or computer program product. Accordingly, embodiments may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language including Java, Smalltalk, C++, and procedural programming languages, including the “C” programming language or similar programming languages. The program code may be executable entirely on the user's computer, partly on the user's computer, as a stand-alone software package, partly on the user's computer and partly on a remote computer, or entirely on the remote computer or server. In the latter scenario, the remote computer may be connected to the user's computer through any suitable network, including a local area network or a wide area network, or the connection may be made to an external computer (for example, through the Internet using an Internet Service Provider).

Embodiments are described with reference to flowchart illustrations and/or block diagrams of methods, apparatus (systems), and computer program products. Each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, where the instructions, which execute via the processor of the computer or other programmable data processing apparatus, create means for implementing the operations specified in the flowchart and/or block diagram blocks.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the embodiments are described with reference to various implementations and exploitations, it will be understood that these embodiments are illustrative and that the scope of the disclosure is not limited to them. In general, techniques for organization of objects and connections in a diagram as described herein may be implemented with any hardware system or hardware systems. Many variations, modifications, additions, and improvements are possible.

Boundaries between various components, operations and data stores may be implemented differently than described herein. Structures/functionality presented as a single component may be implemented as separate components/operations. Structures/functionality presented as a plurality of components/operations may be implemented as a single component. These and other variations, modifications, additions, and improvements may fall within the scope of the disclosure.

What is claimed is:

1. A method for processing wireless wide area network paging messages comprising:
receiving, in a fixed device over a wireless local area network (WLAN) interface, a request to monitor wireless wide area network (WWAN) paging messages for a mobile device;
receiving, by the fixed device via a WWAN interface, a WWAN paging message of the WWAN paging messages; and
forwarding, by the fixed device via the WLAN interface, the WWAN paging message to the mobile device.

2. The method of claim 1, wherein the request is associated with a paging frame number and a paging occasion associated with the mobile device.

3. The method of claim 2 further comprising:
receiving, by the fixed device, a plurality of the WWAN paging messages associated with the paging frame number and the paging occasion;
forwarding, to the mobile device, the plurality of the WWAN paging messages associated with the paging frame number and the paging occasion.

4. The method of claim 1, wherein the request includes one or more parameters for determining a paging frame number and a paging occasion associated with the mobile device, and the method further comprising:
determining, by the fixed device based on the one or more parameters; and
the paging frame number and the paging occasion associated with the mobile device.

5. The method of claim 4 further comprising:
monitoring, by the fixed device via the WWAN interface, for the WWAN paging message based on the paging frame number and the paging occasion associated with the mobile device.

6. The method of claim 4, wherein the one or more parameters include an International Mobile Subscriber Identity (IMSI) and a System Architecture Evolution Temporary Mobile Subscriber Identity (S-TMSI) associated with the mobile device.

7. The method of claim 4 further comprising:
determining, by the fixed device, that the WWAN paging message includes one of an IMSI and an S-TMSI associated with the mobile device.

8. The method of claim 1, wherein the mobile device is an intended recipient of the WWAN paging message received through the WWAN interface.

9. The method of claim 1 further including:
forwarding, by the fixed device, the WWAN paging message to another mobile device.

10. A method for a mobile device to off-load processing of wireless wide area network paging messages, the method comprising:
transmitting, to a fixed device over a wireless local area network (WLAN), a request to monitor wireless wide area network (WWAN) paging messages for the mobile device;
putting a WWAN interface of the mobile device in a long sleep mode during which the mobile device does not process communications over a WWAN; and
receiving, from the fixed device over the WLAN, a WWAN paging message of the WWAN paging messages.

11. The method of claim 10 further comprising:
determining that the fixed device is authentic and has a certain configuration;
registering with the fixed device, wherein the registering includes transmitting the request.

12. The method of claim 11 further comprising:
determining that the fixed device is within a specified proximity to the mobile device.

13. The method of claim 10 further comprising:
transmitting, over the WLAN to the fixed device, information indicating a paging frame number and paging occasion associated with the mobile device.

14. The method of claim 13 further comprising:
receiving, from the fixed device, some of the WWAN paging messages associated with the paging frame number and paging occasion.

15. The method of claim 10 further comprising:
determining that the mobile device is not an intended recipient of the WWAN paging message.

16. The method of claim 10, wherein the request is associated with one of an International Mobile Subscriber Identity (IMSI) associated with the mobile device and a System Architecture Evolution Temporary Mobile Subscriber Identifier (S-TMSI) associated with the mobile device.

17. A fixed device configured to process wireless wide area network paging messages for a mobile device, the fixed device comprising:
a processor;
a wireless local area network (WLAN) interface;
a WWAN (WWAN) interface;
one or more computer readable storage mediums including program code executable on the processor, the program code including instructions to
receive, over the WLAN interface, a request to monitor WWAN paging messages for the mobile device;
receive, through the WWAN interface, a WWAN paging message of the WWAN paging messages; and
forward, via the WLAN interface, the WWAN paging message to the mobile device.

18. The fixed device of claim 17, wherein the request is associated with a paging frame number and a paging occasion associated with the mobile device.

19. The fixed device of claim 18 wherein the instructions are further to:
receive certain of the WWAN paging messages associated with the paging frame number and the paging occasion;
forward, to the mobile device, the certain of the WWAN paging messages associated with the paging frame number and the paging occasion.

20. The fixed device of claim 18, wherein the request includes one or more parameters for determining a paging frame number and a paging occasion associated with the mobile device, and the instructions further to:
determine, by the fixed device based on the one or more parameters, the paging frame number and the paging occasion associated with the mobile device.

21. The fixed device of claim 20, the instructions further to:
monitor, via the WWAN interface, for the WWAN paging message based on the paging frame number and the paging occasion.

22. The fixed device of claim 18, wherein the one or more parameters include an International Mobile Subscriber Identity (IMSI) or a System Architecture Evolution Temporary Mobile Subscriber Identifier (S-TMSI) or any other Similar Identifier associated with the mobile device.

23. The fixed device of claim 17, the instructions further to:
determine, by the fixed device, that the WWAN paging message includes one of an IMSI and an S-TMSI associated with the mobile device.

24. The fixed device of claim 17, wherein the mobile device is an intended recipient of the WWAN paging message received through the WWAN interface.

25. A mobile device configured to off-load wireless wide area network (WWAN) paging message processing, the mobile device comprising:
a processor;
a wireless local area network (WLAN) interface;
a WWAN interface;
one or more computer readable storage mediums including program code executable on the processor, the program code including instructions to:
transmit, to a fixed device through WLAN interface, a request to monitor WWAN paging messages for the mobile device;
put the WWAN interface into a long sleep mode during which the mobile device does not process communications over the WWAN interface; and
receive, from the fixed device over the WLAN, a WWAN paging message.

26. The mobile device of claim 25, the instructions further to:
transmit, over the WLAN, information indicating a paging frame number and paging occasion associated with the mobile device.

27. The mobile device of claim 26 wherein the instructions are further to:
receive, from the fixed device, some of the WWAN paging messages associated with the paging frame number and paging occasion.

28. The mobile device of claim 25 wherein the instructions are further to:
determine that the fixed device is authentic and has a certain configuration; and
register with the fixed device, wherein the registering includes transmitting the request.

29. The mobile device of claim 28 wherein the instructions are further to:
determine that the fixed device is within a specified proximity to the mobile device.

30. The mobile device of claim 25, the instructions further to:
determine that the WWAN paging message does not include an identifier associated with the mobile device.
